(19) United States
(12) Patent Application Publication
(10) Pub. No.: US 2006/0231582 A1
(43) Pub. Date: Oct. 19, 2006

(54) Stapler

(75) Inventors: Ho Chi Hong, Hong Kong (HK); Chen Peng, Xinyang (CN)

Correspondence Address: BRINKS HOFER GILSON & LIONE, P.O. BOX 10395, CHICAGO, IL, 60610, US

(73) Assignee: Eastway Fair Company Limited

(21) Appl. No.: 11/110,084

(22) Filed: Apr. 14, 2005

(51) Int. Cl. B25C 5/06

(52) U.S. Cl. 227/109; 227/120

(57) ABSTRACT

A stapler includes a housing, a magazine, a guide plate, and a driving mechanism. The housing has a base with a driving end. The magazine is associated with the base and has a plurality of sidewalls defining a channel. The guide plate is connected to the base at the driving end and has a face oriented towards the magazine. An inner channel is formed within an outer channel along the face. The drive mechanism is disposed within the housing and has a driver with a free end. The driver slidably extends between a first position between the guide plate and the magazine and a second position in the housing.

The present invention relates to a stapler and in particular to a stapler that is adapted to drive staples of multiple shapes.

### BACKGROUND

Staplers are well known hand tools that are adapted to drive staples of varying shapes and sizes into a workpiece. Staplers have been designed to drive multiple types of staples. For example, U.S. Pat. No. 5,884,829 to Wingert discloses a dual purpose staple gun tacker having a driver with a concave edge that can drive both T-50® and T-25® staples, available from the Arrow Fastener Company, Inc. In addition, U.S. Pat. No. 6,345,754 to Jeng and U.S. Pat. No. 5,794,832 to Chen disclose magazines for staplers that can hold a variety of staples and nails.

It would still be beneficial to provide a stapler that can accommodate different shapes and styles of staples while reducing the frequency of jams or misfires.

### BRIEF SUMMARY

According to the present invention a stapler is provided with a guide plate. In one embodiment, the guide plate is formed with an outer channel to guide flat crown staples and brad nails, and a recessed inner channel to guide round crown staples. The magazine is formed with longitudinally extending sidewalls forming a channel. Round crown staples are accommodated inside the channel, while flat crown staples and brad nails ride along the top and outside of the sidewalls. In addition, the magazine may include a pusher with an inner frame for engaging round crown staples and an outer frame for engaging flat crown staples and brad nails. Moreover, the stapler is equipped with a driver having an arcuate cut-out. An arcuate edge on the cut-out engages round crown staples, while flat segments along the driver engage flat crown staples or brad nails. Advantageously, round crown nails are guided along the recessed inner channel of the guide plate, while flat crown staples and brad nails are guided along the outer channel of the guide plate. This prevents the smaller round crown staples or brad nails from becoming misaligned as they are driven by the driver in the guide channel. This results in reduced jams and improved stapling function.

In accordance with one embodiment of the present invention, a stapler includes a housing, a magazine, a guide plate, and a driving mechanism. The housing has a base with a driving end. The magazine is associated with the base and has a plurality of sidewalls defining a channel. The guide plate is connected to the base at the driving end and has a face oriented towards the magazine. An inner channel is formed within an outer channel along the face. The drive mechanism is disposed within the housing and has a driver with a free end. The driver slidably extends between a first position between the guide plate and the magazine and a second position in the housing.

The magazine may also include a pusher that is biased towards the guide plate and is slidably disposed along the plurality of sidewalls. The pusher may comprise an inner frame connected to an outer frame, wherein the inner frame is slidably disposed within the channel, and the outer frame is slidably disposed along the plurality of sidewalls.

### BRIEF DESCRIPTION OF THE DRAWINGS

FIG. 1 is a perspective view of one embodiment of the stapler of the present invention.

FIG. 2A is a detail perspective view of the magazine shown loaded with T-25 staples.

FIG. 2B is a detail perspective view of the magazine shown loaded with T-50 staples.

FIG. 2C is a detail perspective view of the magazine shown loaded with brad nails.

FIG. 3A is a detail perspective view of the guide plate shown loaded with a T-25 staple.

FIG. 3B is a detail perspective view of the guide plate shown loaded with a T-50 staple.

FIG. 3C is a detail perspective view of the guide plate shown loaded with a brad nail.

FIG. 4 is a front view of the free end of the driver shown in relation to a T-25 staple, a T-50 staple, and a brad nail.

FIG. 5A is a perspective view of the stapler shown loaded with T-25 staples. Elements have been removed to better show the engagement of the driver and the T-25 staple.

FIG. 5B is a perspective view of the stapler shown loaded with T-50 staples. Elements have been removed to better show the engagement of the driver and the T-50 staple.

FIG. 5C is a perspective view of the stapler shown loaded with brad nails. Elements have been removed to better show the engagement of the driver and the brad nail.

### DETAILED DESCRIPTION OF THE DRAWINGS AND THE PRESENTLY PREFERRED EMBODIMENTS

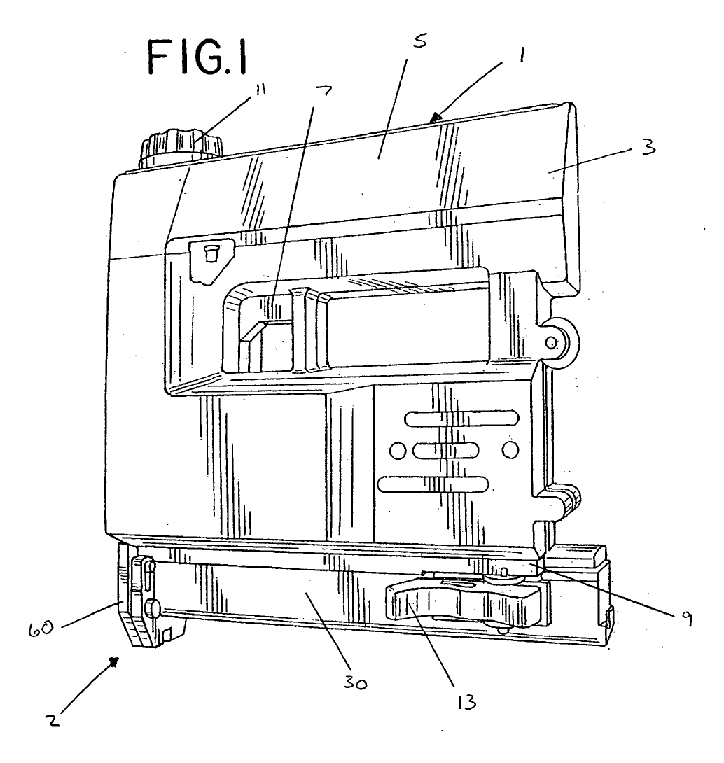

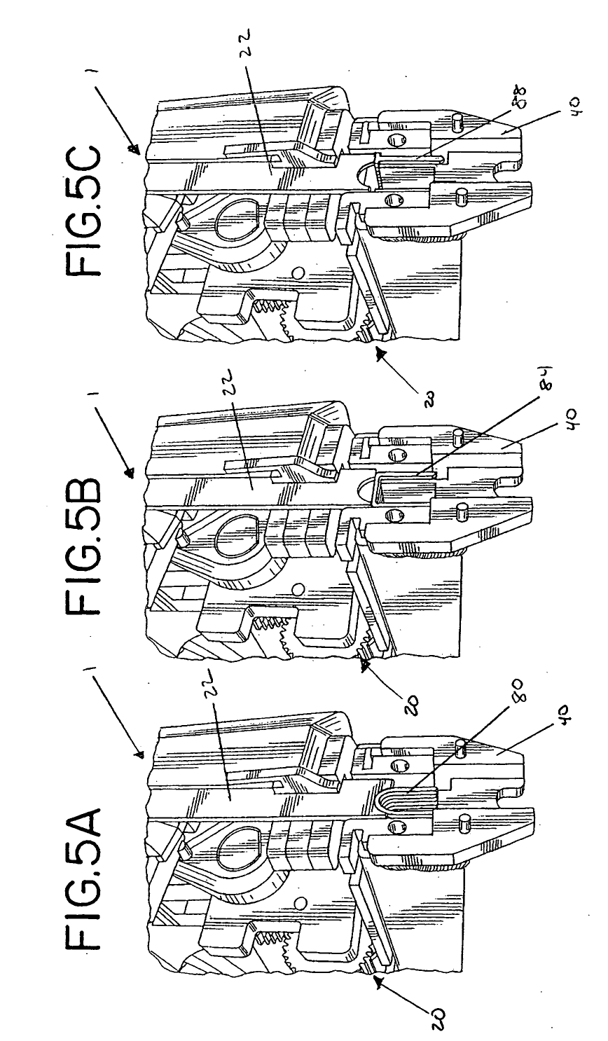

Turning now to FIG. 1, a stapler 1 of the present invention is shown. The stapler 1 includes a housing 3, a handle 5, a drive mechanism 20 (see FIGS. 5A-5C), a magazine 30, and a guide plate 60. The housing 3 is of generally conventional construction and further discussion is not necessary. The handle 5 may have any shape suitable for grasping and may be integrally formed with the housing 3. A trigger 7 located on the handle 5 operates the drive mechanism 20 to power and fire a driver 22 (seen in FIGS. 4-5C) to engage a staple or brad nail and drive it into a workpiece at a driving end 2 of the stapler 1.

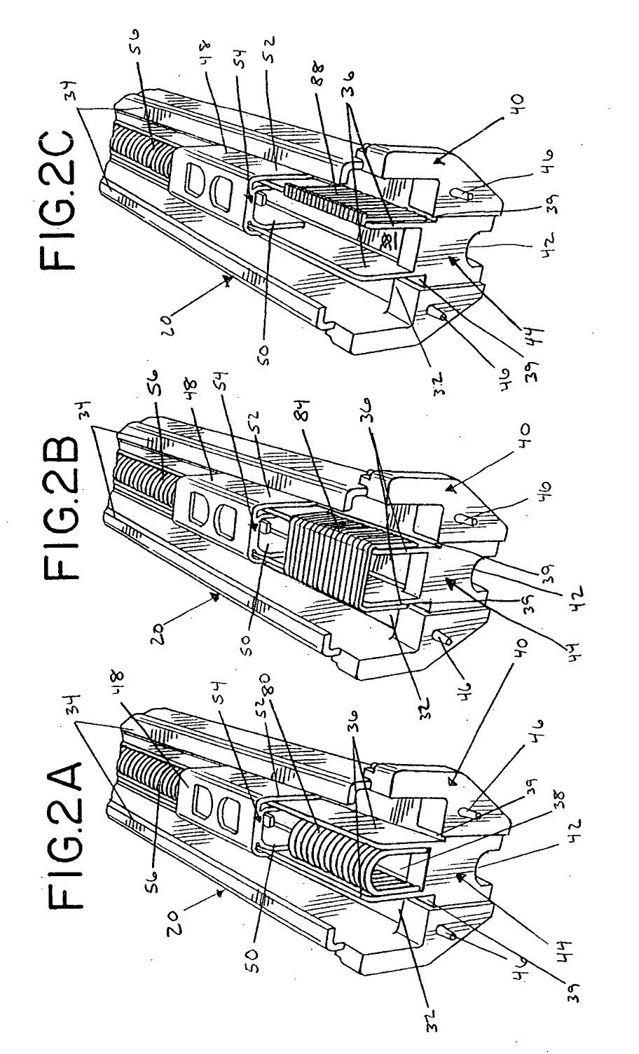

The magazine 30 is mounted within a base 9 of the housing 3. A magazine release 13 on the housing 3 locks or unlocks the magazine 30 to the housing 3. As seen in FIGS. 2A-2C, the magazine 30 includes a magazine body 32 having two rails 34 that engage corresponding grooves (not shown) in the base 9. The body 32 also includes two longitudinally extending sidewalls 36. The sidewalls 36 form a “U”-shaped channel 38 in the body 32 that extends substantially along the length of the magazine 30. The inside of the channel 38 is sized to accommodate a T-25® round crown staple 80, as is seen in FIG. 2A. As seen in FIG. 2B, the sidewalls 36 may be spaced approximately ⅜ inch apart to accommodate a T-50® flat crown staple 84. The height of sidewalls 36 may also be sized to accommodate varying lengths of brad nails 88, ranging from lengths of ⅝ inches to 1¼ inches, although the sidewalls 36 may also be sized to accommodate longer or shorter lengths. Alternately, the body 32 may have longitudinal recesses 39 extending along the outside of sidewalls 36 that increase the effective height of the sidewalls 36.

The body 32 of the magazine 30 also includes a guide face 40 at the driving end 2. As is seen in FIGS. 2A-2C, the guide face 40 may include a concave or rounded cut-out 42. The guide face 40 may also include a recess 44 sized to guide flat crown staples 84. In addition, the guide face 40 may also include a plurality of locators 46.

The magazine 30 also includes a pusher 48. The pusher 48 is formed from two “U”-shaped frames, an inner frame 50 nested within and connected to an outer frame 52. The pusher 48 rides along the sidewalls 36, with the inner frame 50 positioned in the channel 38, and the outer frame 52 positioned over the sidewalls 36. The pusher 48 may be stamped or formed from a single sheet of sheet metal, although other materials and construction methods may also be used. A spring 56 biases a leading edge 54 of the pusher 48 into engagement with the staples or brad nails loaded within the magazine 30. FIGS. 2A-2C illustrate the spring 56 as a compression spring, although other types of springs may also be used.

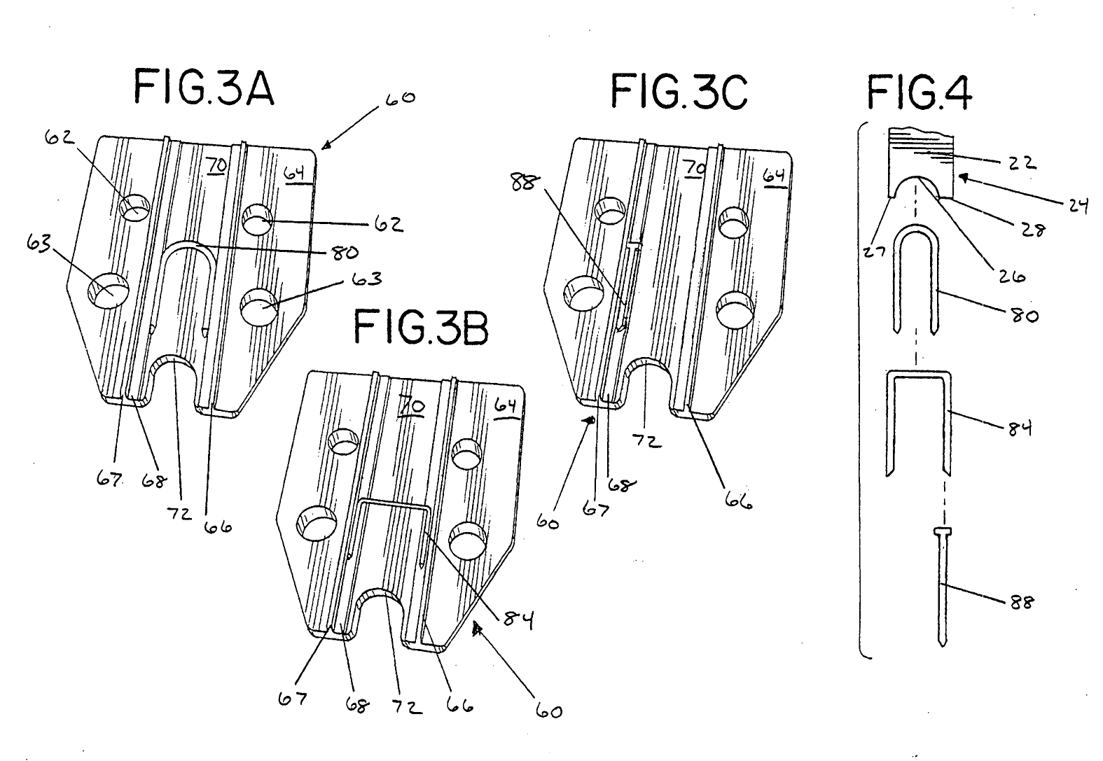

Screws or bolts (not shown) may fasten the guide plate 60 to the base 9 of the housing 3 through a plurality of mounting holes 62. The locators 46 on the magazine 30 engage corresponding locating holes 63 in the guide plate 60 to align the magazine 30 with the guide plate 60. As seen in FIGS. 3A-3C, a front face 64 of the guide plate 60 has two longitudinally extending guide rails 66, 67. The guide rails 66, 67 may be integrally formed with the guide plate 60 and form an outer channel 68 extending longitudinally along the front face 64. The distance between the guide rails 66 and 67 is governed by the width of a flat crown staple 84, as best seen in FIG. 3B. An inner channel or recess 70 is also formed along the front face 64, inside outer channel 68. The recess 70 has a 0.1 mm depth and a width sized to accommodate a T-25® round crown staple 80. In addition, the guide plate 60 also includes an arcuate cut-out 72.

The drive mechanism 20 may include a motor (not shown), a transmission (not shown), a cam-actuated hammer (not shown), and a driver 22. The motor is preferably an electric motor and is energized by a power source such as a rechargeable battery (not shown) or AC line current. Alternately, the motor can be a pneumatic motor, powered by a pressurized air or hydraulic line, or a hand-operated or gear-driven device. The drive mechanism 20 may also include a transmission made up of coupled gears (not shown) that adjust the output torque or speed from the motor. The transmission drives the cam-actuated hammer against a compression spring (not shown) in the housing. The driver 22 is connected to the hammer, so that as the hammer is driven against the compression spring, the driver 22 moves backward into the housing 3. When the cam reaches a given position, the hammer and the driver 22 are driven towards the driving end 2 by the compression spring.

As seen in FIG. 4, the driver 22 has a free end 24 formed with a concave or rounded cut-out 26. The cut-out 26 may be asymmetrically positioned on the free end 24, such that flat segments 27, 28 formed on either side of the cut-out 26 have different sizes. In addition, the driver 22 may have a thickness of 1 mm±0.1 mm. A depth adjustment knob 11 on the housing 3 allows an operator to control the depth that a staple or nail is driven into a workpiece.

The operation of the stapler 1 will now be described. An operator may load one of T-25® round crown staples 80, T-50® flat crown staples 84, or brad nails 88 into the magazine 30. The staples 80, 84, or nails 88 are supplied in a conventional manner in a strip of staples or nails adhered together. The staples 80, 84, or nails 88 are biased towards the guide plate 60 by the pusher 48 and spring 56.

If, for example, round crown staples 80 are loaded into the magazine 30, the leading edge 54 of the inner frame 50 of the pusher 48 engages the strip of staples 80. The staples 80 are guided along the magazine 30 in the channel 38. As the operator squeezes the trigger 7, the drive mechanism 20 drives the driver 22 into the housing 3. When the driver 22 moves beyond the staples 80, the pusher 48 pushes the strip of staples 80 against the guide plate 60. A single staple 80 from the strip is biased into the recess 70 along the front face 64 of the guide plate 60, as shown in FIG. 3A. When the cam-actuated hammer is released, the hammer and driver 22 are rapidly pushed forward by the compression spring. The arcuate cut-out 26 on the driver 22 engages the rounded crown staple 80, separating the staple 80 from its adjacent staple, and driving the staple along the recess 70 into the workpiece. It will be appreciated that because staples 80 are generally formed from 0.05 inch (1.27 mm) wire, the 0.1 mm recess 70 is suitable to guide the staple into the workpiece and to avoid driving more than a single staple at the same time.

If, for example, flat crown staples 84 are loaded into the magazine 30, the leading edge 54 of the outer frame 52 of the pusher 48 engages the strip of staples 84. The staples 84 are guided along the magazine 30 along the outside of the sidewalls 36. As the operator squeezes the trigger 7, the drive mechanism 20 drives the driver 22 into the housing 3. When the driver 22 moves beyond the staples 84, the pusher 48 pushes the strip of staples 84 against the guide plate 60. A single staple 84 from the strip is biased into outer channel 68 formed from the guide rails 66, 67 along the front face 64 of the guide plate 60, as shown in FIG. 3B. When the cam-actuated hammer is released, the hammer and driver 22 are rapidly pushed forward by the compression spring. The flat segments 27, 28 of the driver 22 engage the flat crown staple 84, separating the staple 84 from its adjacent staple. The flat crown staple 84 is driven along the outer channel 68 and into the workpiece.

If, for example, brad nails 88 are loaded into the magazine 30, the leading edge 54 of the outer frame 52 of the pusher 48 engages the strip of nails 88. The nails 88 are guided along the magazine 30 along the outside and top of one of the sidewalls 36. As the operator squeezes the trigger 7, the drive mechanism 20 drives the driver 22 into the housing 3. When the driver 22 moves beyond the nails 88, the pusher 48 pushes the strip of nails 88 against the guide plate 60. A single nail 88 from the strip is biased into the outer channel 68, against the guide rail 67, along the front face 64 of the guide plate 60. When the cam-actuated hammer is released, the hammer and driver 22 are rapidly pushed forward by the compression spring. The larger flat segment 28 of the driver 22 engages the head of the nail 88, separating the nail 88 from the adjacent nail. The nail 88 is driven along the guide rail 67 in the outer channel 68 and into the workpiece.

While the invention has been described in conjunction with specific embodiments it is to be understood that many alternatives, modifications, and variations will be apparent to those skilled in the art in light of the foregoing detailed description. For example, while the invention has been described with reference to an electric motor, other sources of power for the drive mechanism may also be used, such as manually compressed springs, pneumatic drives, etc. Moreover, alternate shapes and sizes for the flat segments on the driver may also be used, such that the driver may have rounded or pointed segments. It is therefore intended that the foregoing description be regarded as illustrative rather than limiting, and that it be understood that it is the following claims, including all equivalents, that are intended to define the spirit and scope of this invention. For example, while several or the parts have been described as being formed as separate parts, it is possible to form them as a single piece.

1. A stapler comprising:
a. a housing having a base with a driving end;
b. a magazine associated with the base and having a plurality of sidewalls defining a channel;
c. a guide plate connected to the base at the driving end and having a face oriented towards the magazine, wherein an inner channel is formed within an outer channel along the face; and
d. a drive mechanism disposed within the housing and having a driver with a free end that slidably extends between a first position between the guide plate and the magazine and a second position in the housing.

2. The stapler of claim 1 wherein the free end of the driver has an arcuate cut-out.

3. The stapler of claim 1 wherein the magazine further includes a pusher that is biased towards the guide plate and is slidably disposed along the plurality of sidewalls.

4. The stapler of claim 3 wherein the pusher comprises an inner frame slidably disposed within the channel and connected to an outer frame slidably disposed along the plurality of sidewalls.

5. The stapler of claim 1 wherein the channel of the magazine and the inner channel of the guide plate is sized for a T-25 staple.

6. The stapler of claim 5 wherein the plurality of side walls are spaced so that a T-50 staple may extend over the sidewalls and the outer channel of the guide plate is sized for a T-50 staple.

7. The stapler of claim 1 wherein the inner channel is approximately 0.1 mm deep.

8. A stapler comprising:
a. a housing having a base with a driving end;
b. a magazine connected to the base and having a plurality of sidewalls defining a channel;
c. at least one staple disposed within the magazine;
d. a guide plate connected to the base at the driving end and having a face oriented toward the magazine, wherein an inner channel is formed within an outer channel along the face; and
e. a drive mechanism disposed within the housing and having a driver to drive the at least one staple into a workpiece, where the driver has a free end that slidably extends between a first position that is between the guide plate and the magazine and a second position within the housing.

9. The stapler of claim 8 wherein the at least one staple is a T-25 staple, a T-50 staple, or a brad nail.

10. The stapler of claim 9 wherein the free end of the driver has an arcuate cut-out.

11. The stapler of claim 9 wherein the magazine further includes a spring and a pusher, wherein the pusher is biased by the spring towards the guide plate and is slidably disposed along the plurality of sidewalls, and wherein the pusher engages the at least one staple.

12. The stapler of claim 9 wherein the pusher comprises an inner frame slidably disposed with the channel and connected to an outer frame slidably disposed along the plurality of sidewalls.

13. The stapler of claim 8 wherein the channel of the magazine and the inner channel of the guide plate is sized for a T-25 staple.

14. The stapler of claim 9 wherein the plurality of side walls are spaced so that a T-50 staple may extend over the sidewalls and the outer channel of the guide plate is sized for a T-50 staple.

15. The stapler of claim 8 wherein the magazine has a guide face at the driving end, wherein the guide face is connected to the guide plate.

16. The stapler of claim 15 wherein the guide face and guide plate have a rounded cut-out.

17. The stapler of claim 8, wherein the drive mechanism includes an electric motor that powers a hammer connected to the driver.

18. The stapler of claim 8 wherein the inner channel is approximately 0.1 mm deep.
